(19) United States
(12) Patent Application Publication
(10) Pub. No.: US 2023/0400299 A1
(43) Pub. Date: Dec. 14, 2023

(54) Method and Device for Determining an Absolute Rotational Position of a Shaft

(71) Applicant: Lenord, Bauer & Co. GmbH, Oberhausen (DE)

(72) Inventors: Reiner Breer, Hamm (DE); André Hessling, Wesel (DE); Axel Nobbe, Essen (DE); Carsten Schumann, Dorsten (DE); Peter Velling, Oberhausen (DE)

(21) Appl. No.: 18/035,530

(22) PCT Filed: Nov. 5, 2021
(86) PCT No.: PCT/DE2021/200176

§ 371 Date: May 5, 2023

(30) Foreign Application Priority Data
Nov. 6, 2020 (DE) 102020006829.4

(51) Int. Cl. G01B 21/22

(52) U.S. Cl. CPC G01B 21/22

(57) ABSTRACT

The invention relates to a method for capturing an absolute rotational position of a shaft using at least two rotational material measures which are synchronously coupled to the shaft, comprising material measures with a different number of graduations which are each relatively prime in pairs, a determination of the state of the individual material measures by means of sensors, wherein a quantizable number of rotational states Ni is captured for each material measure, the total measurement range of the capture system is determined by the product N=πᵢ₌₁ Nᵢ of the possible states of all material measure, and each combination of states (a₀, a₁, a₂, . . . , aₙ) occurs exactly once within the total measurement range N, with the result that the absolute position of the shaft can be determined at any time from the combination of states of the material measures. In order to obtain a high resolution and a wide measurement range, provision is made for some of the material measures to have a multiple of the required graduation for determining the states and/or for at least individual material measures to be used in a cascaded and state-synchronous manner.

### CROSS REFERENCE TO RELATED APPLICATIONS

This application is the U.S. national stage of International Application No. PCT/DE2021/200176, filed on 2021 Nov. 5. The international application claims the priority of DE 102020006829.4 filed on 2020 Nov. 6; all applications are incorporated by reference herein in their entirety.

### BACKGROUND

The invention relates to a method for capturing an absolute rotational position of a shaft using at least two rotational material measures which are synchronously coupled to the shaft, comprising material measures with a different number of graduations which are each relatively prime in pairs (relativ prim), a determination of the state of the individual material measures by means of sensors, wherein a quantizable number of rotational states Ni is captured for each material measure, the total measurement range of the capture system is determined by the product N=πᵢ₌₁ Nᵢ of the possible states of all material measures, and each combination of states (a₀, a₁, a₂, . . . , aₙ) occurs exactly once within the total measurement range N, with the result that the absolute position of the shaft can be determined at any time from the combination of states of the material measures, and a device for applying the method.

To control and monitor large machine systems, it is often important to change settings at the machine system. To this end, adjusting spindles with shafts are used, for example, which are moved via handwheels, actuators or position indicators. For this purpose, for example, the rotational position of a shaft within one revolution has to be exactly captured, optionally taking into consideration a plurality of individual revolutions. Typically, the revolution and also the angular position are determined via noncontact sensors. Here, it has priority that the absolute position of the shaft can be unambiguously determined. For this purpose, permanent magnets and magnetic-field sensors are used, for example. Here, it is a prerequisite that the magnetic-field sensors can each capture the position of the sensor wheel unambiguously within one revolution or a partial revolution. As an alternative, optical, inductive or capacitive position detections can be accomplished; for these, too, the position must be unambiguously captured within one revolution.

It is known from prior art to use transmissions for capturing a number of revolutions which mesh with a same speed reduction of 1:16, for example, and can resolve and metrologically capture 4,096 revolutions or 2¹² bit with a three-stage structural shape with a triple speed reduction. The number of revolutions is here determined by the speed reduction. With a triple speed reduction, these are thus 16×16×16=4,096 revolutions. It is furthermore known from prior art to digitally capture the determined position of the shaft, as is described in DE 19 658 440 C2. The patent specification relates to a digital position indicator with a housing in which a counter with number rollers on a roll axis is integrated, and a drive shaft to be placed on a rotatable element is provided, wherein the counter and the drive shaft are connected to each other via a transmission.

An analogue position indication is furthermore known from DE 10 044 130 C1 in which a shaft on the machine side is coupled, for example, to a spindle shaft which is integrated in a handwheel. During the rotation of the handwheel, here a change of the position directly occurs which is indicated analogously. For this purpose, a torque has to be transmitted in the rotational movement, so that an interlocking joint with the machine's shaft is required. From EP 3 150 972 A2, an electronic capture with an indication of the angular position is known.

From DE 20 2015 102 907 U1, a position indication is known which is equipped with a battery to supply the existing electronic components and permanently store the stored measured values to fetch them at any time. Here, there is a risk in that in case of a failure of the battery, the stored information get lost and the position indication has to be referenced again, for example by fixing a zero point position. Such referencing is very complicated and should be avoided, if possible.

From DE 19855960 A1, a device and a method for measuring the angular position of a rotatable body are known, wherein material measures with a different number of graduations are used, which are moreover relatively prime in pairs.

### SUMMARY

The invention relates to a method for capturing an absolute rotational position of a shaft using at least two rotational material measures which are synchronously coupled to the shaft, comprising material measures with a different number of graduations which are each relatively prime in pairs, a determination of the state of the individual material measures by means of sensors, wherein a quantizable number of rotational states Ni is captured for each material measure, the total measurement range of the capture system is determined by the product N=πᵢ₌₁ Nᵢ of the possible states of all material measure, and each combination of states (a₀, a₁, a₂, . . . , aₙ) occurs exactly once within the total measurement range N, with the result that the absolute position of the shaft can be determined at any time from the combination of states of the material measures. In order to obtain a high resolution and a wide measurement range, provision is made for some of the material measures to have a multiple of the required graduation for determining the states and/or for at least individual material measures to be used in a cascaded and state-synchronous manner.

### DETAILED DESCRIPTION

The technical problem underlying the present invention is to provide a method for capturing a rotational position of a shaft and exemplary embodiments which avoid the known drawbacks of prior art and moreover permit a position indication of the rotational shaft with high resolution that can be fetched at any time.

To solve the technical problem for the method, it is provided that by material measures which partially include a multiple of the required graduation for determining the states, and/or at least individual material measures are used in a cascaded and state-synchronous manner. Further advantageous embodiments of the method result from the subclaims.

To capture the rotational position of a shaft, at least two, preferably three material measures are used which in this case include material measures having a different number of graduations for the method which are each relatively prime in pairs (relativ prim). Thus, there are no common divisors, so that a capturing of the state is possible via the material measures. Here, the particularity is that in the capturing of the states of the individual material measures by corresponding sensors, for each material measure, a quantizable number of rotational states Nᵢ is captured. The total measurement range of such a capture system is determined by the product N=πᵢ₌₁ Nᵢ of the possible states of all material measures. Each combination of states (a₀, a₁, a₂, . . . , aₙ) within the total measurement range N occurs exactly only once due to the selected graduation, so that at any time, the absolute position of the shaft can be determined from the combination of states of the material measures. Of course, the number of material measures can be easily increased if care is taken that the graduation is each relatively prime in pairs. Here, the material measures partially have a multiple of the required graduation for determining the states. A multiple of the graduation increases the resolution of the rotational position of the shaft, wherein at least individual material measures, optionally also all material measures, can be used in a cascaded and state-synchronous manner. In this context, cascaded means that not only one material measure is synchronously coupled to the shaft, but the material measure can be synchronously coupled to further material measures. In this design, too, the graduation is relatively prime in pairs, and a higher total measurement range is achieved.

The advantageous method for capturing the rotational position of a shaft will be illustrated below with reference to exemplary embodiments.

If, for example, three sensor gear wheels are used as material measures having a suited different number of teeth, e. g. 17, 18 and 19, which are synchronously coupled to the shaft and fulfill the condition that the number of teeth is relatively prime in pairs (relativ prim), each combination of states only occurs once. Here, a rotational movement of the shaft is transmitted directly to all sensor gear wheels. There is a direct coupling of the sensor gear wheels to a toothing of the shaft, so that with each rotational movement of the shaft, the sensor gear wheels are moved along. The different number of teeth is used as the graduation of the material measures. The movement of the sensor gear wheels is captured by sensors, and thus a state is detected which, for the three sensor gear wheels with a relatively prime number of gear wheels, always results exactly in one combination of states. In case of a state-synchronous coupling to the shaft, thus all sensor gear wheels are synchronously moved along, and, for example, the respective position of the sensor gear wheels can be determined by sensing a permanent magnet which are connected with the sensor gear wheels, for example by means of magnetic-field sensors. The method here operates without any voltage supply because the rotation of the sensor gear wheels is also performed in an energy-free state, and upon switching on, the positions of the sensor gear wheels can be immediately determined, and each subsequent rotational movement can be immediately captured, and thus an absolutely correctly determined combination of states is present at any time. This unambiguous combination of states corresponds to a certain number of revolutions and the respective rotational position within one revolution of the shaft. If the shaft is, for example, driven manually, and the rotational movement is transmitted to a production plant to be controlled by controlling elements, the exact position of the respective controlling elements in the production plant can be determined and monitored at any time. An indication on a display here serves for a direct visual control of the set position, while the shaft is adjusted manually. Instead of a manual adjustment, an electromotive adjustment could be accomplished via actuators.

To support format adjustments in a production plant, or, for example, a bottling line, a plurality of these indications can be connected with a higher-level plant control via suited electronic interfaces, wherein via this plant control, the individual position fields can be transmitted to the digital indication and represented on the integrated display if a manual adjustment is required. Alphanumeric indications or graphic symbols can indicate that the desired target position is reached. Graphic symbols can moreover represent further information independent of language, so that, for example, the direction in which the shaft of the digital position indication is to be operated can be indicated.

The particular advantage of the indicated method according to the aforementioned example is here that the method can be performed independent of voltage, and due to the positions of the individual material measures which are determined via the sensors, an immediate determination of states is possible, wherein each combination of states only occurs once within the total measurement range, and thus the combination of states of the material measures determines the absolute position of the shaft. The combination of states is here associated with a certain number of revolutions of the shaft and the angular position of the shaft within one revolution to be able to exactly determine the position of the shaft in this manner.

In a further exemplified embodiment, the shaft can be equipped with at least one gear wheel as a material measure which has a multiple of the required graduation for the determination of the states and has the advantage that the gear wheel can have any selected diameter independent of the diameter of the shaft.

In a further exemplified embodiment, a toothed rack with a plurality of teeth can be used as the material measure for determining the position of a sensory mechanism, the toothed rack being movable along the gear wheel. In this case, the sensory mechanism can be part of a slide of a machine component, for example a power loom. In both last mentioned exemplified embodiments, the gear wheels of the sensory mechanism which mesh either with the gear wheel of the shaft or the toothed rack in a state-synchronous manner have a clearly smaller diameter.

In a development of the invention, three or four rotational material measures are coupled to the shaft in order to increase the number of possible combinations of state. Typically, already two rotational material measures are sufficient, wherein, however, preferably three or four rotational material measures are coupled to the shaft to achieve a higher total measurement range of the system. Here, a direct synchronous or slip-free coupling of the material measure with the shaft is always given. A slip-free coupling can consist, for example, of a sprocket belt which is coupled to the material measure of the shaft and the sensory mechanism.

In a further development of the invention, the absolute position of the shaft or position on the toothed rack is determined by calculation via the combination of states. By the evaluation of the combination of states, the position of the shaft or sensory mechanism can also be determined again at any time after a standstill or voltage failure without requiring complicated measurements or a new referencing.

As material measures, for example, permanent magnets or signal-influencing elements can be used. If, for example, permanent magnets are employed, by means of sensor elements, the graduations can be sensed, and thereby, a state position can be captured. If signal-influencing elements, such as, for example, metallic coding, are used, magnetic-field sensors or capacitive sensors can be used which exactly capture the absolute position of the shaft via the respective state of the material measures.

The employed measuring principle for capturing the position is here based, for example, on a noncontact sensing of permanent magnets of the material measures by means of suited sensors. The material measures are each located in direct engagement with the shaft. The sensors can consist, for example, of Hall or magneto-resistive sensors, as long as they unambiguously each capture the position of the material measure within one revolution or a partial revolution.

Furthermore, the respective states of the material measure can be captured by optical, capacitive, inductive, or resistive sensors and be evaluated to determine the respective state and to determine the absolute position of the shaft via the combination of states.

For example, for the method, a material measure of sensor gear wheels with a different number of teeth as graduation can be used, as described in the first embodiment, which offer the possibility of determining the respective state of the individual sensor gear wheels. As an alternative, it is possible that the material measures consist of a code disk with a different number of signal-changing elements as the graduation. For the respective graduations, be it the teeth or the signal-changing elements, there here always is the boundary condition that the graduation is relatively prime in pairs.

The particular advantage of the indicated method is here that even in case of a standstill or after a voltage drop, a reliable determination of the rotational position of a shaft and the number of revolutions is possible at any time, and the states of the material measures present here only occur once each, so that a direct association with the absolute position of the shaft is possible, for example, via a table of states. The position of the shaft can here be immediately determined both after a voltage failure and after a standstill of a production plant without requiring a complicated referencing. The total measurement range of the detection system can here be successively improved by increasing the material measures and thus be individually adapted to each production plant.

To solve the technical problem, by way of example, individual devices will be described below for the application of the method which can be used for capturing a rotational position of a shaft independent of its activation.

A first embodiment comprises at least one housing with a manually rotatable hollow shaft whose absolute rotational position is to be determined, wherein the rotational position of the hollow shaft can be transmitted to a production plant to be controlled via controlling elements, and wherein a direct coupling of the hollow shaft with at least two material measures is accomplished which have a different number of graduations which are each relatively prime in pairs (relativ prim) and can be sensed by a sensor. Taking the method as a basis, it is here provided according to the invention that the material measures at least partially include a multiple of the required graduation for determining the states, and/or at least individual material measures are arranged in a cascaded and state-synchronous manner.

The device thus discloses a measurement system that can be mounted on a shaft and captures the angular position of this shaft within one revolution as well as the number of revolutions and can indicate them on a display. The indication on a display here serves for a direct visual control of the set position, while the shaft is adjusted manually. The manual adjustability of the hollow shaft has priority because the hollow shaft has a direct influence on a production plant to be controlled via controlling elements. The production plant can consist, for example, of a major bottling line for beverages, wherein for each conversion to a new type of bottle, corresponding controlling elements have to be typically adjusted manually or in an electromotive manner. To this end, it is necessary to perform an adjustment either via a controlling element or, as an alternative, manually, wherein in this case, a rotatable hollow shaft is accommodated in a housing which is simultaneously equipped with a display to indicate the current position of the hollow shaft. To support the format adjustment of a bottling line, a plurality of these indications can be connected with a higher-level plant control via suited electronic interfaces, so that a monitoring of the complete plant is possible. Via the plant control, the position values to be adjusted are transmitted to the digital indications and indicated on the integrated display. For example, an alphanumeric indication and/or graphic symbols can show that the target position is reached. Graphic symbols have the advantage that the information can be represented independent of language. For example, the direction in which the digital position indication is to be operated can be indicated. Due to the high luminosity of the displays used, their bright blinking supports the finding of all indications in complex machines and long production lines. Insofar, an indication by LEDs can be omitted.

A second embodiment relates to a shaft with an optionally very small or very large diameter. Independent of the shaft diameter, in this case, a material measure in the form of a gear wheel is used which can be, on the one hand, coupled directly to the shaft, and on the other hand, for example, offers the possibility of using individual gear wheel segments which can be manufactured in a particularly cost-effective manner. In this case, it is, for example, possible to use plastic gear wheels consisting of a plurality of segments and being directly connected with each other and coupled to the shaft. The diameter of the gear wheel as the material measure is here selected such that a multiple of the required graduation is present so that a high resolution can be achieved. By means of a low-pass filter, in such a case, irregularities, for example transition points of the individual segments, can be filtered out, and insofar, reliable signals can be generated which permit, using the method according to the invention, an exact determination of the position of the shaft in view of the rotational position and the present revolutions. The sensory mechanism used herein is also equipped with sensor gear wheels which mesh with the material measure of the shaft, where the diameter of them can be made to be clearly smaller. As the sensor gear wheels of the sensory mechanism mesh with the material measure of the shaft in a state-synchronous manner and can optionally also be arranged in a cascaded manner, a high resolution on the one hand, and a wide measurement range on the other hand can be achieved.

A third embodiment has a toothed rack as a material measure on which a sensory mechanism with sensor gear wheels is located which in turn mesh with the toothed rack. The toothed rack as such already offers a multiple of the required graduation for determining the individual states for the determination of the position of the sensory mechanism, and by the use of sensor gear wheels of the sensory mechanism with a small diameter, a wide measurement range can be realized by a state-synchronous coupling with the toothed rack. In this case, it is also possible to employ a cascaded arrangement of sensor gear wheels. The employed sensory mechanism can here be part of a slide which is movable along the toothed rack and thus permits a determination of the position with respect to the toothed rack at any time. The slide can be, for example, a weaving slide.

The devices are furthermore based on a noncontact sensing of material measures, wherein preferably, sensor gear wheels with permanent magnets can be employed which are sensed with magnetic-field sensors. The material measures, in the exemplified embodiments the sensor gear wheels, are each located in direct engagement with a material measure of the shaft, toothed rack or hollow shaft, wherein each rotational movement of the shaft or the hollow shaft, respectively, is directly transmitted to the sensor gear wheels. Equally, the sensor gear wheels of the sensory mechanism can be caused to rotate and sensed in a movement with respect to the toothed rack. The magnetic-field sensors can here be Hall or magneto-resistive sensors and only have to each unambiguously capture the position of the sensor gear wheel within one revolution or partial revolution. Equally, other optical, inductive or capacitive position detections are possible as long as the position is unambiguously determined within a defined revolution range.

For the material measures, different graduations are used which are each relatively prime in pairs (relativ prim). The number of material measures can be arbitrarily increased, one only has to ensure here that two material measures each are relatively prime in order to avoid double conditions of the respective material measures. Insofar as, for example, three material measures with a graduation of 17, 18 and 19 are used, 5,800 states can already be resolved, so that a wide total measurement range is provided with corresponding precision. The individual material measures are here sampled by sensors in order to determine the respective state, wherein the combination of states of all material measures occurs exactly only once since the material measures are synchronously coupled to the shaft, the hollow shaft or the toothed rack. Via the combination of states, thus the absolute position of the shaft or the sensory mechanism with respect to the toothed rack can be determined. Here, the particularity is that in the capturing of the state of the individual material measures by corresponding sensors for each material measure, a quantizable number of rotational states N1 is captured. The total measurement range of the capture system is determined by the product N=πᵢ₌₁ Nᵢ of the possible states of all material measures.

Preferably, three or four rotational material measures are coupled to the shaft in order to obtain the desired total measurement range. The coupling to the shaft is here performed directly synchronously, or there is a slip-free coupling of the material measure to the shaft, for example by a sprocket belt.

The absolute position of the shaft is determined by sensing or capturing the angular positions of the individual material measures and subsequent calculation. In this manner, thus an absolute position determination both after a standstill of the production plant and a voltage failure can be accomplished at any time. The same applies for a toothed rack with a sensory mechanism.

Typically, only material measures are employed which are directly coupled to the shaft or the hollow shaft synchronously and can, for example, consist of gear wheels. However, it is possible that one material measure is coupled to a plurality of sensor gear wheels in a cascaded and state-synchronous manner. In case of sensor gear wheels, these can be two coupled, state-synchronous sensor gear wheels, wherein additionally, by the cascaded arrangement of the sensor gear wheels, the total measurement range is increased. Here, it is easily possible for individual material measures to include a multiple of the required graduation for determining the states, so that the resolution is also increased.

Preferably, the material measures can consist of permanent magnets or signal-influencing elements which can be evaluated by means of sensor elements. As sensor elements, optical, capacitive, inductive or resistive sensors our possible which determine the respective state of the material measures. As an alternative to gear wheels and sensor gear wheels, a material measure in the form of a coding disk with a different number of signal-influencing elements can also be used as the graduation, wherein in turn it has to be ensured that the number of graduations is each relatively prime in pairs (relativ prim). In this case, optical or magnetic sensors are preferably employed. By the relatively prim embodiment of the material measures, a possibility is created to achieve a combination of states with a wide total measurement range with a corresponding number of coding or toothing, and by each combination of states exactly occurring only once within the total measurement range, at any time the absolute position of the shaft or the sensory mechanism with respect to a toothed rack can be determined from the combination of state of the material measures.

Both the method and the device are characterized in that they operate in a de-energized state and thus also ensure a reliable statement on the shaft position or the position of the sensory mechanism with respect to a toothed rack even in case of a standstill of the production plant, or when it is restarted, or in case of a mains failure.

### BRIEF DESCRIPTION OF THE DRAWINGS

The invention will be illustrated more in detail below with respect to the embodiments in the figures.

In the drawings:

FIG. 1 shows an only schematically represented position indication in a front view and a side view,

FIG. 2 shows a first arrangement of sensor gear wheels in a schematic front view,

FIG. 3 shows a second arrangement of sensor gear wheels in a schematic front view,

FIG. 4 shows a third arrangement of sensor gear wheels in a schematic front view,

FIG. 5 shows an arrangement according to FIG. 3 with permanent magnets in a schematic front view

FIG. 6 shows an embodiment of the position indication with an inductive position determination of the shaft in a schematic side view,

FIG. 7 shows two possible variations of a shaft with a material measure and sensory mechanism in a schematic view, and

FIG. 8 shows a toothed rack with a sensory mechanism in a schematic view.

### DETAILED DESCRIPTION OF THE PREFERRED EMBODIMENTS

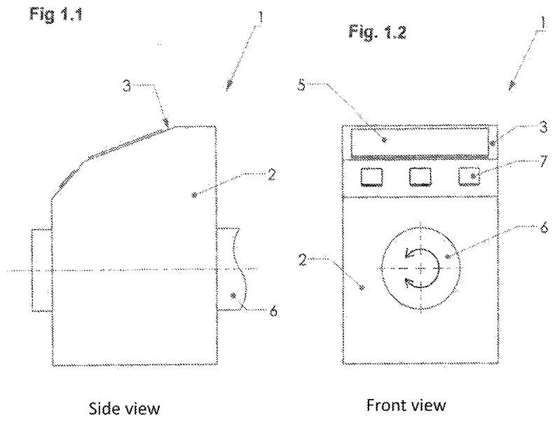

FIG. 1 shows a position indication 1 in a schematic front view and a side view. The position indication 1 consists of a housing 2 with a chamfered edge 3. The chamfered edge 3 is equipped with a graphic display 5. A manually rotatable hollow shaft 6 is located in the lower half of the housing 2, wherein in this case, no bearing elements or mountings for the hollow shaft 6 are shown. The hollow shaft 6 can be manually rotated in both directions in order to adjust a predetermined position adjustment. The hollow shaft 6 is furthermore connected to non-depicted controlling elements, so that a manual rotation of the hollow shaft can be directly transmitted to the production plant to be controlled. In the embodiment, furthermore, three sensors 7 are shown which permit a configuration and parameterization of the apparatus.

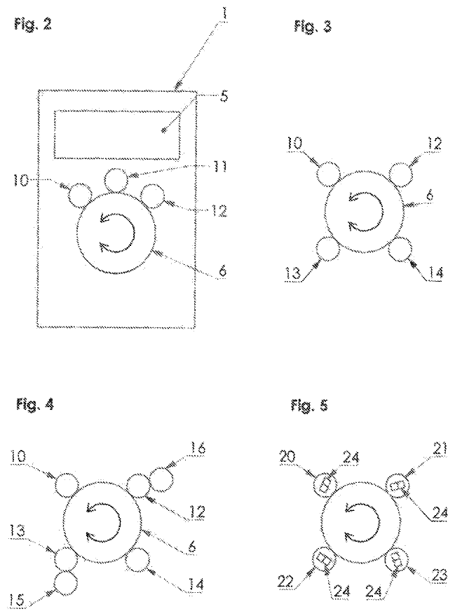

The position indication 1 is used in a multiple design in a larger production plant to transmit certain controls via controlling elements at the production plant. If the plant is, for example, a bottling line for bottles, by means of the position indication 1, an adaption to another type of bottle can be accomplished, wherein the shown position indication is provided for manual adjustment. As an alternative, however, actuators could be provided which are remote-controlled from a central position. To determine the rotational position of the hollow shaft 6, the method according to the invention is applied, that means, material measures are employed which are directly synchronously coupled to the hollow shaft 6. The position of the individual material measures is obvious from the following FIGS. 2 to 5, wherein the method according to the invention is applied in order to determine a combination of states (a₀, a₁, a₂, . . . aₙ) and to determine the absolute rotational position of the hollow shaft from them.

FIG. 2 shows, in a schematic view, the position indication 1 with the hollow shaft 6 as well as three material measures 10, 11, 12 which are synchronously coupled to the hollow shaft 6. By means of these material measures 10, 11, 12, there is already the possibility of capturing a total measurement range of approximately 5,800 states, taking into consideration a selected graduation which is relatively prim. The material measures 10, 11, 12 have a relative prim graduation, so that the position of the hollow shaft 6 can even be exactly determined after several revolutions with respect to the number of revolutions and the angular position.

FIG. 3 shows, in a schematic view, a further embodiment of a hollow shaft 6 which is provided with four material measures 10, 12, 13, 14. By the higher number of material measures 10, 12, 13, 14, a wider total measurement range of the position indication 1 is achieved.

FIG. 4 shows, in a schematic view, the hollow shaft 6 with four material measures 10, 12, 13, 14 according to FIG. 3, wherein the material measures 12, 13 have a cascaded arrangement and are synchronously coupled to two further material measures 15, 16. By the further use of material measures 15, 16, the measurement range of the position indication 1 can be further improved. Here, it is not relevant whether the material measures are coupled to the hollow shaft 8 in a cascaded manner or directly.

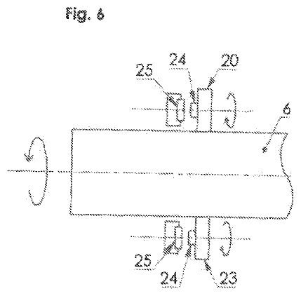

FIG. 5 shows, in a schematic view, the hollow shaft 6 with material measures 20, 21, 22, 23 wherein each material measure 20, 21, 22, 23 is equipped with a permanent magnet 24. The permanent magnets 24 are rotated along by the synchronous coupling to the hollow shaft 6 during each rotational movement of the hollow shaft 6, so that the rotational position of the permanent magnets 24 can be captured by non-depicted sensors. Due to the relatively prime graduation of the material measures 20, 21, 22, 23, thus, an exact determination of the shaft rotation and shaft position within one revolution can be determined, as in the previous examples. The particularity of this material measure is that the functioning is also given in a de-energized state, and after a standstill of the shaft and a restart of a production plant, the determined revolutions and rotational positions of the hollow shaft 6 can be immediately determined again via the sensors.

FIG. 6 shows, in a schematic view, the functioning of the permanent magnets 24 in connection with a sensor 25. Each material measure 20, 21, 22, 23 is fitted with a permanent magnet 24 and coupled to the hollow shaft 6, so that a rotational movement of the hollow shaft 6 is directly transmitted to the material measure 20, 21, 22, 23. By the firm connection of the material measures 20, 21, 22, 23 with the permanent magnets 24, these are rotated along, and via the sensors 25, the position of the permanent magnets 24 in the respective sense of rotation can be unambiguously determined. By the material measures 20, 21, 22, 23 being relatively prime, in a rotation of the hollow shaft 6, for each rotational position, there is a combination of states which only occurs once, and thus, the number of rotations of the hollow shaft 6 and the rotational position within one revolution are exactly fixed.

The various embodiments of the hollow shaft 6 with material measures are to be considered only as examples. It is easily possible to use other embodiment variants which are employed on the basis of the method according to the invention.

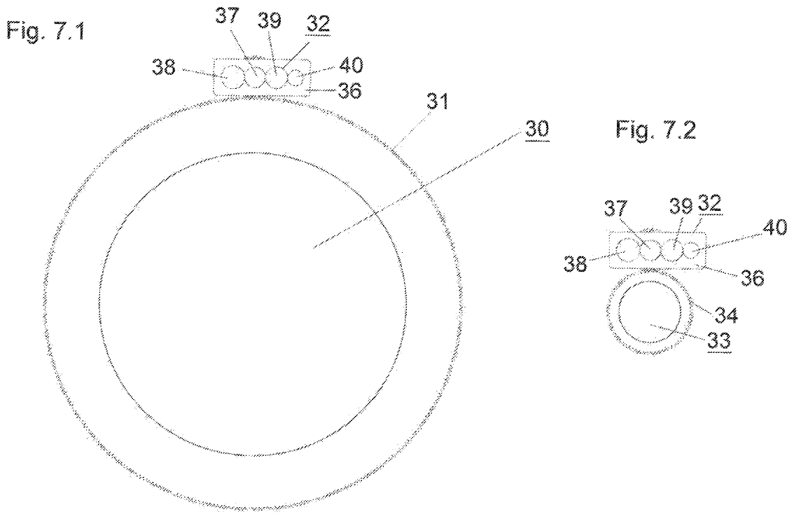

FIG. 7 shows, in a schematic view, two solutions for a large shaft 30 with a material measure 31 and a sensory mechanism 32 as well as a small shaft 33 with a material measure 34 and a sensory mechanism 32. The two shafts 30, 33 have different diameters, wherein the respective material measures 31, 34 are independent of the shaft's diameter. The sensory mechanism is represented schematically in both cases in the form of a housing 36 with a first sensor gear wheel 37 and further cascade-like sensor gear wheels 38, 39, 40, so that there is a cascaded arrangement of the sensor gear wheels 37, 38, 39, 40. The first sensor gear wheel 37 meshes with the material measure 31 in case of the shaft 30, and with the material measure 34 in case of the shaft 33.

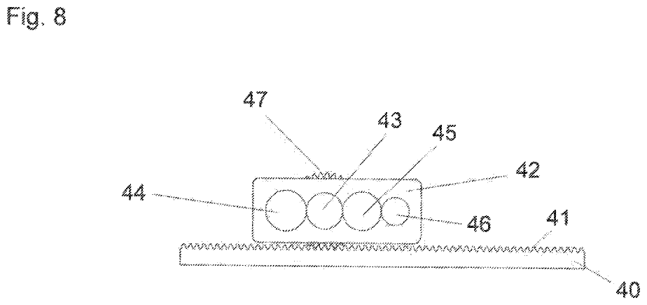

FIG. 8 shows, in a schematic view, a further embodiment with a toothed rack 40 and the corresponding toothing 41. A sensory mechanism 42 with a first sensor gear wheel 43 is furthermore equipped with a cascaded arrangement of sensor gear wheels 44, 45, 46. The first sensor gear wheel 43 meshes with its teeth 47 with the toothed rack 40, wherein in this case, too, the sensory mechanism 42 has a cascaded arrangement of further sensor gear wheels 43, 44, 45, 46.

Both embodiments both for the shafts 30, 33 and for the toothed rack 40 permit a high resolution and a wide measurement range due to the cascaded arrangement and the state-synchronous coupling of the individual sensor gear wheels 37, 38, 39, 40, 43, 44, 45, 46 of the sensory mechanism 32, 42 to the corresponding material measure.

### LIST OF REFERENCE NUMERALS

1 position indication
2 housing
3 chamfered edge
5 display
6 hollow shaft
7 pushbutton
10 material measure
11 material measure
12 material measure
13 material measure
14 material measure
15 material measure
16 material measure
20 material measure
21 material measure
22 material measure
23 material measure
24 permanent magnet
25 sensor
30 shaft
31 material measure
32 sensory mechanism
33 shaft
34 material measure
35 sensory mechanism
36 housing
37 sensor gear wheel
38 sensor gear wheel
39 sensor gear wheel
40 toothed rack
41 toothing
42 sensory mechanism
43 gear wheel
44 sensor gear wheel
45 sensor gear wheel
46 sensor gear wheel
47 teeth

1. Method for capturing an absolute rotational position of a shaft (30, 33) using at least two rotational material measures (10, 11, 12, 13, 14, 15, 16, 20, 21, 22, 23, 31, 34) which are synchronously coupled to the shaft (30, 33) comprising material measures (10, 11, 12, 13, 14, 15, 16, 20, 21, 22, 23, 31, 34) with a different number of graduations which are each relatively prime in pairs (relativ prim), a determination of the state of the individual material measures (10, 11, 12, 13, 14, 15, 16, 20, 21, 22, 23, 31, 34) by sensors (25), wherein a quantizable number of rotational states Ni is captured for each material measure (10, 11, 12, 13, 14, 15, 16, 20, 21, 22, 23, 31, 34), the total measurement range of the capture system is determined by the product N=πᵢ₌₁ Nᵢ of the possible states of all material measures (10, 11, 12, 13, 14, 15, 16, 20, 21, 22, 23, 31, 34), and each combination of states (a₀, a₁, a₂, . . . , aₙ) occurs exactly once in the total measurement range N, with the result that the absolute position of the shaft (30, 33) can be determined at any time from the combination of states of the material measures (10, 11, 12, 13, 14, 15, 16, 20, 21, 22, 23, 31, 34),
characterized by material measures (10, 11, 12, 13, 14, 15, 16, 20, 21, 22, 23, 31, 34) which partially have a multiple of the required graduation for determining the states, and/or at least individual material measures (10, 11, 12, 13, 14, 15, 16, 20, 21, 22, 23, 31, 34) are used in a cascaded and state-synchronous manner.

2. Method according to claim 1,
characterized in that
three or more rotational material measures (10, 11, 12, 13, 14, 15, 16, 20, 21, 22, 23, 31, 34) are coupled to the shaft (30, 33), and/or that a direct, synchronous or slip-free coupling of the material measures (10, 11, 12, 13, 14, 15, 16, 20, 21, 22, 23, 31, 34) to the shaft (30, 33) is present.

3. Method according to claim 1,
characterized in that
the absolute position of the shaft (30, 33) is determined by calculation via the combination of states (a₀, a₁, a₂, . . . , aₙ), and or an absolute position determination is determined after a standstill or voltage failure via the combination of states (a₀, a₁, a₂, . . . , aₙ).

4. Method according to claim 1,
characterized in that
the material measures (10, 11, 12, 13, 14, 15, 16, 20, 21, 22, 23, 31, 34) consist of permanent magnets (24) or signal-influencing elements, and/or that the states of the material measures (10, 11, 12, 13, 14, 15, 16, 20, 21, 22, 23, 31, 34) are evaluated by optical, capacitive, inductive, or resistive sensors (25).

5. Method according to claim 1, that the material measure (10, 11, 12, 13, 14, 15, 16, 20, 21, 22, 23, 31, 34) consists of sensor gear wheels (37, 38, 39, 40, 43, 40, 45, 46) with a different number of teeth (47) as a graduation, or that the material measure (10, 11, 12, 13, 14, 15, 16, 20, 21, 22, 23, 31, 34) consists of a coding disk with a different number of signal-changed elements as a graduation.

6. Device for capturing a rotational position of a shaft (30, 33) independent of it being switched on, comprising at least one housing (2) with a manually rotatable hollow shaft (6) whose absolute rotational position is to be determined, wherein the rotational position of the hollow shaft (6) can be transmitted to a production plant to be controlled via controlling elements, and wherein a direct coupling of the hollow shaft (6) to at least two material measures (10, 11, 12, 13, 14, 15, 16, 20, 21, 22, 23, 31, 34) is accomplished which have a different number of graduations which are each relatively prime in pairs (relativ prim) and can be sensed by a sensor (25),
characterized in that
the material measures (10, 11, 12, 13, 14, 15, 16, 20, 21, 22, 23, 31, 34) at least partially have a multiple of the required graduation for determining the states, and/or at least individual material measures (10, 11, 12, 13, 14, 15, 16, 20, 21, 22, 23, 31, 34) are arranged in a cascaded and state-synchronous manner.

7. Device for capturing a rotational position of a shaft (30, 33) independent of it being switched on whose absolute rotational position, or the position of a sensory mechanism (42) with respect to a toothed rack (40), is to be determined, wherein a coupling of the shaft (30, 33) or the toothed rack (40), respectively, to at least two sensor gear wheels (37, 38, 39, 40, 43, 44, 45, 46) of a sensory mechanism (32, 35, 42) which have a different number of graduations which are each relatively prime in pairs (relativ prim) is accomplished,
characterized in that
the shaft (30, 33) is equipped with at least one gear wheel as a material measure (31, 34) which has a multiple of the required graduation for determining the states and is designed independent of the diameter of the shaft (30, 33), or a toothed rack (40) with a plurality of teeth (47) for determining the position of the sensory mechanism (42), wherein the sensor gear wheels (37, 38, 39, 40, 43, 44, 45, 46) of the sensory mechanism (32, 35, 42) are equipped with a clearly smaller diameter which mesh with the gear wheel of the shaft (30, 33) or the toothed rack (40), respectively, in a state-synchronous manner.

8. Device according to claim 6,
characterized in that
a determination of states of the individual material measures (10, 11, 12, 13, 14, 15, 16, 20, 21, 22, 23, 31, 34) is accomplished by sensors (25), wherein each material measure (10, 11, 12, 13, 14, 15, 16, 20, 21, 22, 23, 31, 34) is defined by a quantizable number of rotational states Nᵢ.

9. Device according to claim 6,
characterized in that
the total measurement range is determined by the product N=πᵢ₌₁ Nᵢ of the possible states of all material measures (10, 11, 12, 13, 14, 15, 16, 20, 21, 22, 23, 31, 34).

10. Device according to claim 6,
characterized in that
each combination of states (a₀, a₁, a₂, . . . , aₙ) occurs exactly once in the total measurement range N, with the result that the absolute position of the shaft (30, 33) can be determined at any time from the combination of states of the material measures (10, 11, 12, 13, 14, 15, 16, 20, 21, 22, 23, 31, 34).

11. Device according to claim 6,
characterized in that
three or four rotational material measures (10, 11, 12, 13, 14, 15, 16, 20, 21, 22, 23, 31, 34) are coupled to the shaft (30, 33), and/or a direct, synchronous or slip-free coupling of the material measures (10, 11, 12, 13, 14, 15, 16, 20, 21, 22, 23, 31, 34) to the shaft (30, 33) is present.

12. Device according to claim 6,
characterized in that
an absolute position determination is determined after a standstill or voltage failure via the combination of states (a₀, a₁, a₂, . . . , aₙ), and/or the absolute position of the shaft (30, 33) can be determined by a comparison of tables via the combination of states (a₀, a₁, a₂, . . . , aₙ).

13. Device according to claim 6,
characterized in that
the material measures (10, 11, 12, 13, 14, 15, 16, 20, 21, 22, 23, 31, 34) consist of permanent magnets (24) or signal-influencing elements, and/or the states of the material measures (10, 11, 12, 13, 14, 15, 16, 20, 21, 22, 23, 31, 34) are evaluated by optical, capacitive, inductive, or resistive sensors (25).

14. Device according to claim 6,
characterized in that
the material measure is composed of individual angular segments in the form of a gear wheel (37, 38, 39, 40, 43, 44, 45, 46) and is connected with a shaft (30, 33), and/or the material measure is present in the form of a gear wheel (37, 38, 39, 40, 43, 44, 45, 46) independent of the diameter of the shaft (30, 33).

15. Device according to claim 6,
characterized in that
the material measure (10, 11, 12, 13, 14, 15, 16, 20, 21, 22, 23, 31, 34) consists of sensor gear wheels with a different number of teeth as a graduation, or the material measure (10, 11, 12, 13, 14, 15, 16, 20, 21, 22, 23, 31, 34) consists of a coding disk with a different number of signal-generating elements as a graduation.
